(19) United States
(12) Patent Application Publication
(10) Pub. No.: US 2016/0065878 A1
(43) Pub. Date: Mar. 3, 2016

(54) DISPLAY SYSTEM, TRANSMITTING DEVICE, AND METHOD OF CONTROLLING DISPLAY SYSTEM

(71) Applicant: SEIKO EPSON CORPORATION, Tokyo (JP)

(72) Inventors: Takashi NAGUMO, Yamagata-Mura (JP); Hiroyuki HASHIMOTO, Hara-Mura (JP)

(73) Assignee: SEIKO EPSON CORPORATION, Tokyo (JP)

(21) Appl. No.: 14/830,235

(22) Filed: Aug. 19, 2015

(30) Foreign Application Priority Data
Aug. 29, 2014 (JP) 2014-174860

(51) Int. Cl. H04N 5/38; H04N 7/015

(52) U.S. Cl. CPC H04N 5/38; H04N 7/015

(57) ABSTRACT

A display system includes a transmitting device adapted to transmit video data, and a display device adapted to display a picture based on the video data. The transmitting device includes a wired connection section, and a wireless transmission section adapted to wirelessly transmit the video data. The display device includes a wired connection section, and a wireless reception section adapted to receive the video data, the transmitting device and the display device transmit and receive identification information used in a case in which the wireless transmission section and the wireless reception section perform communication in a state in which the wired connection section of the transmitting device and the wired connection, section of the display device are connected to each other with wire, and perform pairing adapted to associate the transmitting device and the display device with each otter based on the identification information transmitted and received.

The entire disclosure of Japanese Patent Application No. 2014-174860, filed Aug. 29, 2014 is expressly incorporated by reference herein.

### BACKGROUND

1. Technical Field

The present invention relates to a display system, a transmitting device, and a method of controlling the display system.

2. Related Art

In the past, there has been known a method of transmitting data to a display device using wireless communication (see, e.g., JP-A-2013-117860 (Document 1)). In Document 1, there is described a configuration of transmitting image information to a projector as a display device from a transmitter compatible with WirelessHD (registered trademark).

In the case of wirelessly transmitting data to the display device as described in Document 1, there is required a setting called pairing for associating the transmitting device on the transmission side and the display device with each other as communication counterparts. In the past, the pairing has been achieved by the transmitting device and the display device to be associated with each other wirelessly communicating with each other in some cases. However, it has not necessarily been easy to make the transmitting device and the display device correspond to each other as intended to achieve the pairing. For example, in the case in which another device exists in an available range for the wireless communication when performing the pairing, the device and one of the transmitting device and the display device have been associated with each other in some cases. Such a situation can be prevented by making the procedure of the pairing more complicated or by the user performing an input operation. However, since the operation becomes troublesome and complicated, the load of the user problematically increases. Further, in the case in which a change in setting procedure is restricted due to the standard or the specification of the communication protocol, it is not achievable to prevent the situation described above by changing the procedure.

### SUMMARY

An advantage of some aspects of the invention is to provide a display system, a transmitting device, and a method of controlling the display system with which a setting of associating a transmitting device and a display device for wirelessly communicating with each other with each other can surely be achieved as intended when performing the setting,

A display system according to an aspect of the invention includes a transmitting device adapted to transmit video data, and a display device adapted to receive the video data to display a picture based on the video data, the transmitting device includes a wired connection section, and a wireless transmission section adapted to wirelessly transmit the video data, the display device includes a wired connection section, and a wireless reception section adapted to receive the video data, and the transmitting device and the display device transmit and receive identification information used in a case in which the wireless transmission section and the wireless reception section perform communication in a state in which the wired connection section of the transmitting device and the wired connection section of the display device are connected to each other with wire, perform pairing adapted to associate the transmitting device and the display device with each other based on the identification information transmitted and received, and wirelessly transmit the video data from the transmitting device to the display device associated with each other using the pairing.

According to the aspect of the invention, in the case of connecting the transmitting device and the display device to each other with the wireless communication, the transmitting device and the display device can surely be associated with each other with the desired correspondence relationship.

The display system described above may be configured such that the transmitting device is provided with a plurality of the wireless transmission sections, the display device is provided with a plurality of the wireless reception sections, each of the wireless transmission sections provided to the transmitting device is associated with either one of the wireless reception sections provided to the display device to perform wireless transmission, the transmitting device obtains a plurality of partial, video data as parts of the video data, and then transmits the partial video data while assigning any of the partial video data to each of the wireless transmission sections, and the display device receives the plurality of partial video data transmitted by the respective wireless transmission sections using the plurality of wireless reception sections, and then displays the picture based on the plurality of partial video data received.

According to the aspect of the invention with this configuration, it is possible to configure the system for transmitting the video data to the display device as a plurality of partial video data, and it is possible to associate the transmitting device for transmitting the partial video data and the display device with each other as intended using the pairing.

The display system described above may be configured such that the display device displays a picture based on the plurality of the partial video data received by the plurality of the wireless reception sections in accordance with a correspondence relationship between the partial video data received by each of the wireless reception sections and a whole of the video data, and the transmitting device and the display device performs the pairing by associating the wireless transmission section and the wireless reception section with each other so that correspondence between the partial video data transmitted by the wireless transmission section and the whole of the video data and correspondence between the partial video data received by the wireless reception section and the whole of the video data are coincide with each other.

According to the aspect of the invention with this configuration, in the case of transmitting the video data to the display device as a plurality of partial video data, the correspondence between the partial video data and the video data in the display device can be made compatible with the transmitting device. Thus, it is possible for the display device to perform the process suitable for the correspondence between the partial video data and the video data.

The display system described above maybe configured such that the transmitting device has a determination section adapted to determine whether or not a number of the wireless reception sections provided to the display device is smaller than a number of the wireless transmission sections provided to the transmitting device.

According to the aspect of the invention with this configuration, the number of the partial video data and so on to be transmitted by the transmitting device can appropriately be set in accordance with the configuration of the display device.

The display system described above may be configured such that the transmitting device and the display device transmit and receive the identification information including at least either one of information used by the transmitting device for identifying the wireless reception section of the display device, and information used by the display device for identifying the wireless transmission section of the transmitting device.

According to the aspect of the invention with this configuration,- it is possible to associate the transmitting device and the display device with each other based on the identification information to thereby perform the pairing.

The display system described above may foe configured such that the transmitting device transmits video data for connection confirmation to the display device associated by the pairing.

According to the aspect of the invention with this configuration, clue to the function of the transmitting device, the connection to the display device associated therewith by the pairing can be confirmed.

The display system described above may foe configured such that the transmitting device has an operation section adapted to receive an operation, and performs the transmission and the reception of the identification information, and the pairing in accordance with the operation received by the operation section, and the display device starts the transmission and the reception of the identification information and the pairing based on control data transmitted from the transmitting device.

According to the aspect of the invention with this configuration, the pairing between the transmitting device and the display device can be performed in response to the operation to the operation section, provided to the transmitting device.

The display system described above may be configured such that the wired connection section of the transmitting device and the wired connection section of the display device are compatible with an interface adapted to transmit HD video data with wire.

According to the aspect of the invention with this configuration, the identification information can be transmitted and received using the interface for transmitting the HD video data.

A transmitting device according to another aspect of the invention includes a wired connection section to be connected to en external device with wire and a wireless communication section adapted to perform wireless communication with the external device, in a case in which the wired connection section is connected to the external device with, wire, identification information used to identify the external device is obtained from the external device using the wireless communication section, and pairing adapted to associate the wireless communication section with the external device is performed based on the identification information obtained from the external device, and the video data is transmitted from the wireless communication section to the external device associated with each other using the pairing.

According to the aspect of the invention, in the case of connecting the transmitting device to the external device with the wireless communication, the transmitting device and the display device can surely be associated with each other with the desired correspondence relationship.

A method of controlling a display system according to still another aspect of the invention includes providing a transmitting device adapted to transmit video data, and a display device adapted to receive the video data to display a picture based on the video data to the display system, transmitting and receiving identification information, which is used in a case in which the transmitting device and the display device perform wireless communication, via a wired transmission channel connecting the transmitting device and the display device to each other, performing pairing adapted to associate the transmitting device and the display device performing wireless communication with each, other based on the identification information, and transmitting the video data from the transmitting device to the display device, which are associated with each other using the pairing, with wireless communication.

According to the aspect of the invention, in the case of connecting the transmitting device to the external, device with the wireless communication, the transmitting device and the display device can surely be associated with each other with the desired correspondence relationship.

### BRIEF DESCRIPTION OF THE DRAWINGS

The invention will be described with reference to the accompanying drawings, wherein like numbers reference like elements.

FIG. 1 is a diagram showing a configuration of a display system according to a first embodiment.

FIG. 2 is a flowchart showing a procedure of wireless correction.

FIG. 3 is a diagram showing a configuration of a display system according to a second embodiment.

### DESCRIPTION OF EXEMPLARY EMBODIMENTS

### First Embodiment

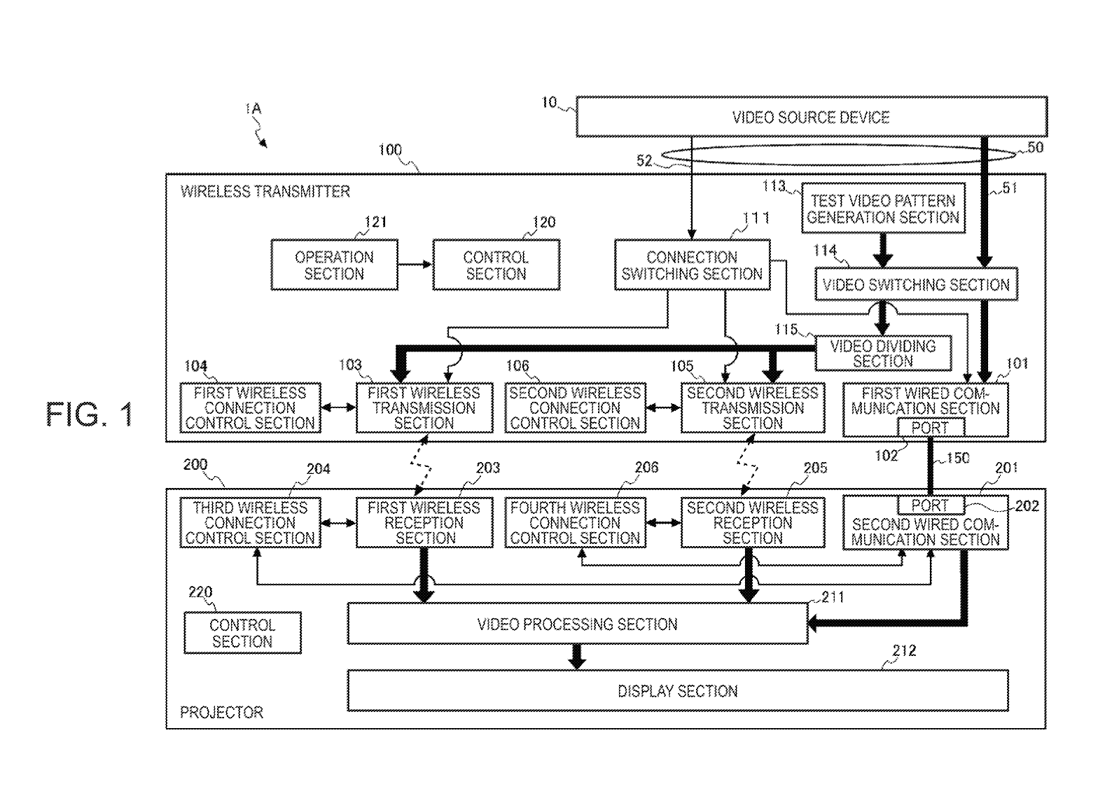

FIG. 1 is a diagram showing a configuration, of a display system 1A according to a first embodiment.

The display system 1A is provided with a wireless transmitter 100 and a projector 200. The wireless transmitter 100 is connected to the projector 200 with a cable 150 in a wired manner. Further, the wireless transmitter 100 is connected to the projector 200 with the wireless communication.

The wireless transmitter 100 is connected to a video source device 10 via a cable 50. The display system 1A is a system, in which the wireless transmitter 100 transmits video data, output by the video source device 10 to the projector 200, and the projector 200 projects (displays) an image based on the video data.

The video source device 10 is a device for supplying the display system 1A with the video data, and is connected to the wireless transmitter 100 via the cable 50 as described above. The video source device 10 is a video output device such as a DVD (digital versatile disk) playback device, a Blue-ray Disk (registered trademark) playback device, or a personal computer. Further, the video source device 10 can also be a television tuner device, a set-top box of a cable television (CATV), a video game device, or the like. Further, a portable device such as a portable video reproduction device or a portable music reproduction device, a portable phone, a smartphone, or a tablet computer can also be used as the video source device 10.

In the present embodiment, there is described an example of connecting the video source device 10, the wireless transmitter 100, and the projector 200 to each other with HDMI (High-Definition Multimedia Interface; registered trademark), The data transmitted and received by the video source device 10, the wireless transmitter 100, and the projector 200 includes video data, audio data, and a CEC command in the HDMI format.

The cable 50 is a cable compatible with the HDMI standard. The cable 50 includes a data line 51 used for transmitting and receiving the video data, the audio data, a sync signal, and so on (hereinafter simply described as the video data), and a CEC line 52 used for transmitting and receiving the CEC (Consumer Electronics Control Line) command.

The wireless transmitter 100 is provided with a first wired communication section 101, a first wireless transmission section 103, a first wireless connection control section 104, a second wireless transmission section 105, and a second wireless connection control section 106. Further, the wireless transmitter 100 is provided with a connection switching section 111, a test video pattern generation section 113, a video switching section 114, a video dividing section 115, a control section 120, and an operation section 121. It should be noted that although the control section 120 is connected to the sections of the wireless transmitter 100 shown in FIG. 1 with control signal lines, the control signal lines are omitted from the graphical description in FIG. 1.

The first wired communication section 101 has a port 102, which is connected to the video switching section 114 and the connection switching section 111, and which the cable 150 is inserted to and pulled cut from. When the cable 150 is connected to the port 102, the first wired communication section 101 detects whether a signal on an HPD (Hot Plug Detection) line included in the cable 150 is High to thereby detect the connection, of a device to the port 102. When the first wired communication section 101 has detected the connection of the device to the port 102, the first wired communication section 101 notifies the control section 120 of the fact that the connection of the device to the port 102 has been detected.

The first wired communication section 101 is compatible with an interface for transmitting HD (high definition) video data with wire, and is compatible with, for example, the HDMI standard. The cable 150 is a cable capable of transmitting the HD video data, and for example, the HDMI cable similar to the cable 50 can be used.

In the case of connecting the wireless transmitter 100 and the projector 200 to each other with the cable 150 without wirelessly connecting the wireless transmitter 100 and the projector 200 to each other, the first wired communication section 101 transmits the video data, which is input via the cable 50, to the projector 200 via the cable 150. Further, the first wired communication section 101 transmits the CEC command, which is input from the connection switching section 111, to the projector 200 via the cable 150.

The first wireless transmission section 103 is connected to the first wireless connection control section 104, the connection switching section 111, and the video dividing section 115.

The first wireless transmission section 103 is a communication module for performing wireless communication with a device (the projector 200 in the present embodiment) to be wirelessly connected to the wireless transmitter 100, The first wireless transmission section 103 is a wireless transmission section compatible with, for example, the WirelessHD standard.

The first wireless transmission section 103 is wirelessly connected to a wireless reception section (e.g., a first wireless reception section 203) of the projector 200 to transmit the video data, which is input from the video dividing section 115, to the projector 200 under the control by the first wireless connection control section 104. Farther, in the case in which the CEC command has been input to the first wireless transmission section 103 from the connection switching section 111, the first wireless transmission section 103 transmits the CEC command thus input to the wireless reception section of the projector 200.

The first wireless connection control section 104 is connected to the first wireless transmission section 103.

The first wireless connection control section 104 controls the first wireless transmission section 103 to connect the first wireless transmission section 103 to the wireless reception section (e.g., the first wireless reception section 203) of the projector 200 to form a wireless communication channel.

Further, the first wireless connection control section 104 stores identification information (hereinafter referred to as first identification information) of the first wireless transmission section 103. Further, the first wireless connection control section 104 obtains the identification information for identifying the wireless reception section of the projector 200, which performs the wireless communication with the first wireless transmission section 103, from the projector 200, and then stores the identification information. In the present embodiment, the first wireless connection control section 104 obtains second identification information as the identification information of the first wireless reception section 203 from the projector 200, and then stores the second identification information. As the first identification information, there cart be used, for example, an MAC address of the first wireless transmission section 103, and as the second identification information, there can be used, for example, an MAC address of the first wireless reception section 203. It should be noted that the procedure of the first wireless connection control section 104 obtaining the second identification information from, the projector 200 will be described later.

The second wireless transmission section 105 is connected to the second wireless connection control section 106, the connection, switching section 111, and the video dividing section 115.

The second wireless transmission section 105 is a communication module for performing wireless communication with a device (the projector 200 in the present embodiment) to be wirelessly connected to the wireless transmitter 100. The second wireless transmission section 105 is a wireless transmission section compatible with, for example, the WirelessHD standard.

The second wireless transmission, section 105 is wirelessly connected to a wireless reception section (e.g., a second wireless reception section 205) of the projector 200 to transmit the video data, which is input from the video dividing section 115, to the projector 200 under the control by the second wireless connection control section 106. Further, in the case in which the CEC command has been input to the second wireless transmission section 105 from the connection switching section 111, the second wireless transmission section 105 transmits the CSC command thus input to the wireless reception section of the projector 200.

The second wireless connection control section 106 is connected to the second wireless transmission section 105.

The second wireless connection control section 106 controls the second wireless transmission section 105 to connect the second wireless transmission section 105 to the wireless reception section (e.g., the second wireless reception section 205) of the projector 200 to form a wireless communication channel.

Further, the second wireless connection control section 106 stores identification information (hereinafter referred to as third identification information) of the second wireless transmission section 105. Further, the second wireless connection control section 106 obtains the identification information for identifying the wireless reception section of the projector 200, which performs the wireless communication with the second wireless transmission section 105, from the projector 200, and then stores the identification information. In the present embodiment, the second wireless connection control section 106 obtains fourth identification information as the identification information of the second wireless reception section 205 from the projector 200, and then stores the fourth identification information. As the third identification information, there can be used, for example, an MAC address of the second wireless transmission section 105, and as the fourth identification information, there can be used, for example, an MAC address of the second wireless reception section 205. It should foe noted that the procedure of the second wireless connection control section 106 obtaining the fourth identification information from the projector 200 will be described later.

The connection switching section 111 is connected to the CEC line 52 included in the cable 50. Further, the connection switching section 111 is connected to the first wired communication section 101, the first wireless transmission section 103, and the second wireless transmission section 105.

The CEC command is input to the connection switching section III via the CEC line 52 in a normal operation mode. The normal operation mode is a mode in which the wireless transmitter 100 is wirelessly connected to the projector 200, and when the video data is supplied from the video source device 10 to the wireless transmitter 100, the video data is transmitted to the projector 200. In the case in which the CEC command is input to the connection switching section 111 via the CEC line 52 in the normal operation mode, the connection switching section 111 outputs the CEC command to the first wireless transmission section 103 or the second wireless transmission section 105. The CEC command is transmitted to the projector 200 by the first wireless transmission section 103 or the second wireless transmission section 105 wirelessly connected thereto.

Further, in the case of connecting the wireless transmitter 100 and the projector 200 to each other with the cable 150 without, wirelessly connecting the wireless transmitter 100 and the projector 200 to each other, the connection switching section 111 outputs the CEC command, which is input via the CEC line 52, to the first wired communication section 101. The first wired communication section 101 transmits the CEC command, which is input from the connection switching section 111, to the projector 200 via the cable 150.

The test video pattern generation section 113 is connected to the video switching section 114. The test video pattern generation section 113 generates test video data (video data for checking the connection) for checking the wireless connection between the first wireless transmission section 103 and the second wireless transmission section 105, and then outputs the test video data to the video switching section 114.

The video switching section 114 is connected to the data line 51 included in the cable 50. Further, the video switching section 114 is connected to the test video pattern generation section 113, the video dividing section 115, and the first wired communication section 101.

The video switching section 114 switches the output destination of the video data, which is input from the video source device 10 via the data line 51, between the first wired communication section 101 and the video dividing section 115 in accordance with the control by the control section 120. In other words, the video switching section 114 outputs the test video data, which is output from the test video pattern generation section 113, to the video dividing section 115 in a pairing mode. The pairing mode is an operation mode of setting the wireless transmitter 100 and the projector 200 to the state in which the wireless communication can be performed. Further, the pairing denotes a series of operations of associating the wireless transmitter 100 and the projector 200 with each other. More specifically,, when the display system 1A performs the pairing, there is performed association between the wireless transmission sections (103, 105) provided to the wireless transmitter 100 and the wireless reception sections (203, 205) provided to the projector 200. It becomes possible to perform, the wireless communication between the wireless transmission sections (103, 105) and the wireless reception sections (203, 205) associated with each other by the pairing.

Further, in the normal mode, in the case in which the video data is input to the video switching section 114 via the data line 51, the video switching section 114 outputs the video data to the video dividing section 115. Further, in the case of connecting the wireless transmitter 100 and the projector 200 to each other with the cable 150 in a wired manner without wirelessly connecting the wireless transmitter 100 and the projector 200 to each other, the video switching section 114 outputs the video data, which is input via the cable 50, to the first wired communication section 101. The video data is output to the cable 150 by the first wired communication section 101, and is then transmitted to the projector 200.

The video dividing section 115 is connected to the video switching section 114, the first wireless transmission section 103, and the second wireless transmission section 105.

The video dividing section 115 divides the video data, which is input from the video switching section 114, in accordance with the control by the control section 120. The video dividing section 115 outputs each of the video data (partial video data) thus divided to the first wireless transmission section 103 or the second wireless transmission section 105 in accordance with the control by the control section 120.

The control section 120 is provided with a CPU as an arithmetic device, a ROM storing a variety of control programs, a RAM used as a working memory when the CPU performs a variety of types of arithmetic processing, and so on as hardware. The control section 120 is connected to the sections of the wireless transmitter 100 shown in FIG. 1 via control signal lines not shown to control the sections.

Further, the control section 120 is connected to the operation section 121. The operation section 121 receives an operation input from the user, and outputs the operation information having been received to the control section 120. For example, in the case in which the setting for making the wireless transmitter 100 operate in the pairing mode is input from the operation section 121, the control section 120 sets the operation mode of the wireless transmitter 100 to the pairing mode. Further, the control section 120 transmits a pairing start request (control data) to the projector 200, which has been connected with wire, to make the projector 200 make the transition to the pairing mode.

Further, it is also possible for the control section 120 to set the wireless transmitter 100 to the pairing mode in the case in which the connection of the cable 150 to the port 102 provided to the first wired communication section 101 has been detected.

The projector 200 is provided with a second wired communication section 201, the first wireless reception section 203, a third wireless connection control section 204, the second wireless reception section 205, a fourth wireless connection control section 206, a video processing section 211, a display section 212, and a control section 220. Although the control section 220 is connected to the sections of the projector 200 shown in FIG. 1 with control signal lines, the control signal lines are omitted from the graphical description in FIG. 1.

The second wired communication section 201 has a port 202, which the cable 150 is inserted in and pulled out from. When the cable 150 is connected to the port 202, the second wired communication section 201 detects whether the signal on the HPD line included in the cable 150 is High to thereby detect the connection of a device to the port 202. When the second wired communication section 201 has detected the connection of the device to the port 202, the second wired communication section 201 notifies the control section 220 of the fact that the connection of the device to the port 202 has been detected.

The second wired communication section 201 is compatible with an interface for transmitting the HD video data with wire, and is compatible with, for example, the HDMI standard.

The first wireless reception section 203 is connected to the third wireless connection control section 204, and the video processing section 211.

The first wireless reception section 203 is a communication module for performing wireless communication with a device (the wireless transmitter 100 in the present embodiment) to be tirelessly connected to the projector 200. The first wireless reception section 203 is a wireless reception section compatible with, for example, the WirelessHD standard.

The first wireless reception section 203 is wirelessly connected to the wireless transmission section (e.g., the first wireless transmission section 103) of the wireless transmitter 100 under the control by the third wireless connection control section 204. The first wireless reception section 203 receives the video data transmitted from the wireless transmitter 100 with the wireless communication, and then outputs the video data thus received to the video processing section 211.

The third wireless connection control section 204 is connected to the second wired communication section 201, and the first wireless reception section 203.

The third wireless connection control section 204 controls the first wireless reception section 203 to connect the first wireless reception section 203 to the wireless transmission section (e.g., the first wireless transmission section 103) of the wireless transmitter 100 to form a wireless communication channel.

Further, the third wireless connection control section 204 obtains the identification information, for identifying the wireless transmission section of the wireless transmitter 100, which, performs the wireless communication with the first wireless reception section 203, from the wireless transmitter 100, and then stores the identification information. In the present embodiment, the third wireless connection control section 204 obtains the first identification information as the identification information of the first wireless transmission section 103 from the wireless transmitter 100, and then stores the first identification information. It should be noted that the procedure of the third wireless connection control section 204 obtaining the first identification information from the wireless transmitter 100 and then storing the first identification information will be described later.

The second wireless reception section 205 is connected to the fourth wireless connection control section 206, and the video processing section 211.

The second wireless reception section 205 is a communication module for performing wireless communication with a device (the wireless transmitter 100 in the present embodiment) to be wirelessly connected to the projector 200. The second wireless reception section 205 is a wireless reception section compatible with, for example, the WirelessHD standard.

The second wireless reception section 205 is wirelessly connected to the wireless transmission section (e.g., the second wireless transmission section 105) of the wireless transmitter 100 under the control by the fourth wireless connection control section 206. The second wireless reception section 205 receives the video data transmitted from the wireless transmitter 100 with the wireless communication, and then outputs the video data thus received to the video processing section 211.

The fourth wireless connection control section 206 is connected to the second wired communication section 201, and the second wireless reception section 205.

The fourth wireless connection control section 206 controls the second wireless reception section 205 to connect the second wireless reception section 205 to the wireless transmission section (e.g., the second wireless transmission section 105) of the wireless transmitter 100 to form a wireless communication channel.

Further, the fourth wireless connection control section 206 obtains the identification information for identifying the wireless transmission section of the wireless transmitter 100, which performs the wireless communication with the second wireless reception section 205, from the wireless transmitter 100, and then stores the identification information. In the present embodiment, the fourth wireless connection control section 206 obtains the third identification information as the identification information of the second wireless transmission section 105 from the wireless transmitter 100, and then stores the third identification information. It should be noted that the procedure of the fourth wireless connection control section 206 obtaining the third identification information from the wireless transmitter 100 and then storing the third identification information will be described later,

The video processing section 211 is connected to the first wireless reception section 203, the second wireless reception section 205, and the display section 212. The video processing section 211 is provided with a frame memory (not shown). The video-processing section 211 determines the image size and the resolution, whether the video data represents a still image or a moving image, an attribute such as a frame rate in the case of a moving image, and so on with respect to the video data having been input from at least, one of the first wireless reception section 203 and the second wireless reception section 205. Then, the video processing section 211 develops the video data on the frame memory frame by frame. Further, the video processing section 211 outputs the image of each of the frames having been developed on the frame memory to the display section 212 as a display signal.

The display section 212 is connected to the video processing section 211, and projects a projection image, which is based on the display signal having been output from the video processing section 211, on a screen.

The control section 220 is provided with a CPU as art arithmetic device, a ROM storing a variety of control-programs, a RAM used as a working memory when the CPU performs a variety of types of arithmetic processing, and so on as hardware. The control section 220 controls the sections of the projector 200 with a cooperation between the hardware such as the CPU and the RAM, and the control programs stored in the ROM.

Further, the ROM of the control section 220 stores determination information for determining whether or not the wireless connection to the projector 200 is possible. The determination information includes supported resolution, pairing information, destination information, and information regarding whether or not a content protection standard is supported.

The supported resolution is the information regarding the resolution of the video data which can be displayed by the projector 200. The frequency band of the video- data to be wirelessly transmitted, to the projector 200 can be obtained based on the support information. Further, it is also possible to obtain the number of channels necessary for the transmission of the video data based on the frequency band thus obtained. In other words, the supported resolution corresponds to the information regarding the number of wireless channels necessary for the wireless communication in the case in which the video data is divided and is then wirelessly transmitted to the projector 200. For example, the supported resolution includes information such as “in the case in which the resolution of the video data is 4 k, the number of necessary wireless channels is two.” It should be noted that the resolution of the so-called 4 k denotes 4096×2160, 4096×2304, 4096×2048, 3940×2160, or the like.

The pairing information includes the information regarding the number of wireless channels in which the projector 200 can perform the communication. The number of wireless channels corresponds to the number of wireless reception sections provided to the projector 200. Since the projector 200 shown in FIG. 1 has two wireless reception sections, namely the first wireless reception section 203 and the second wireless reception section 205, the number of wireless channels is two.

Further, the pairing information includes the identification information of each of the wireless reception sections provided to the projector 200. In the case of the present embodiment, the second identification information of the first wireless reception section 203 and the fourth identification information of the second wireless reception section 205 correspond to the pairing information.

Further, the pairing information includes correspondence information in the case in which the video data is divided into a plurality of parts, and then wirelessly transmitted to the projector 200. The correspondence information includes information representing the correspondence between each of the parts of the video data (partial video data) obtained by dividing the video data and the video data, which is the original to be divided. Specifically, the correspondence information includes information for determining the resolution of the video data subject to the division, information for determining the number of parts the video data is divided into and a method of dividing the video data for each resolution, and information related to the wireless reception section (the wireless channel) of the projector 200 to which the reception function for receiving the video data thus divided is assigned. For example, the correspondence information includes the information of designating 4 k as the resolution of the video data, and the information of designating horizontal bisection for horizontally dividing the frame of the video data into two parts as the number and the method of the division.

Further, the correspondence information includes the identification information (e.g., the second identification information as the identification information of the first wireless reception section 203) of the wireless reception section, to which the reception of the video data corresponding to the left one the two parts obtained by the horizontal bisection is assigned (which is assigned to the reception thereof), as the information of the part of the video data thus divided. Further, the correspondence information includes the identification information (e.g., the fourth identification information as the identification information of the second wireless reception section 205) of the wireless reception section, which is assigned to the reception of the video data corresponding to the right one the two parts obtained by the horizontal bisection, as the information of the part of the video data thus divided.

Further, the destination information is information representing a nation or a region to which the projector 200 is shipped, and the information regarding whether or not the content protection standard is supported is information representing whether or not the projector 200 supports the standard for protecting the content.

When the projector 200 is connected to the wireless

transmitter 100 with the cable 150, and the control section 220 has received the pairing start request (the control data) from the wireless transmitter 100, the control section 220 makes the projector 200 make the transition to the pairing mode. Further, it is also possible for the control section 220 to make the projector 200 make the transition to the pairing mode in the case in which the connection of the cable 150 to the port 202 provided to the second wired communication section 201 has been detected.

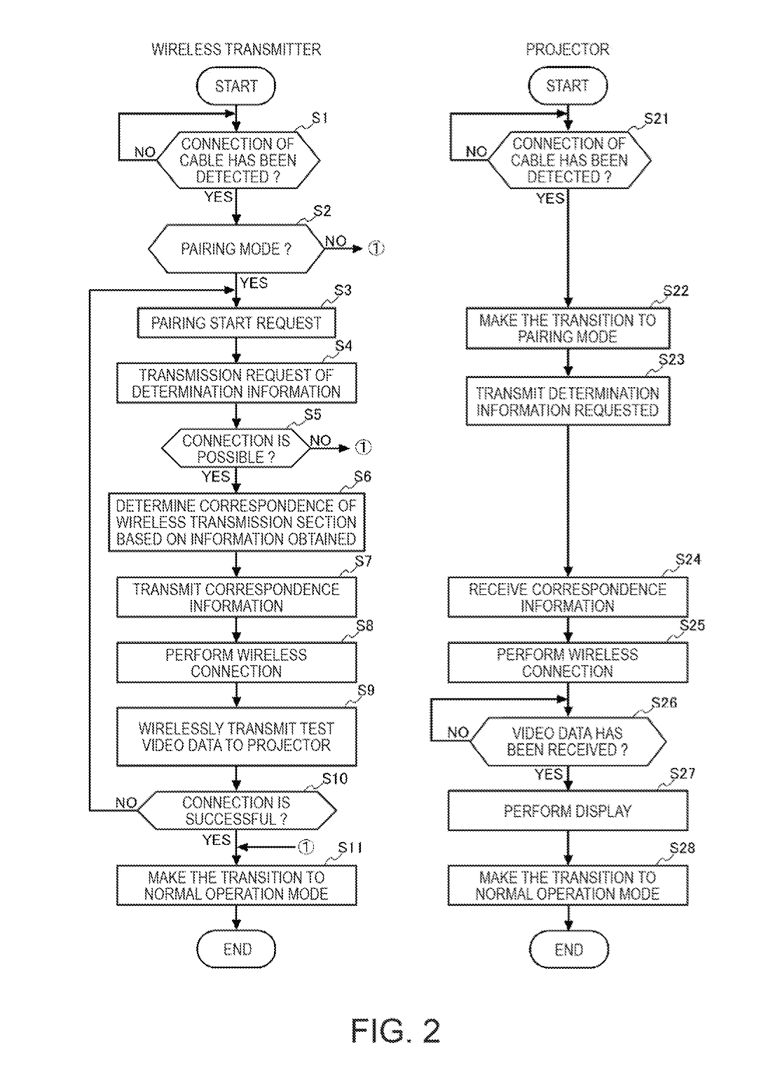

FIG. 2 is a flow chart showing the procedure of the wireless connection between the wireless transmitter 100 and the projector 200.

When the cable 100 is connected to the port 102 and the port 202, the first wired communication section 101 detects the fact that the signal on the HPD line is High to detect (step S1) the fact that the device has been connected to the port 102. When the first wired communication section 101 has detected the connection of the device, the first wired communication section 101 notifies the control section 120 of the fact that the device has been connected to the port 102. The second wired communication section 201 detects the fact that the signal on the HPD line is High to detect (step S21) the fact that the port 202 has been connected to the device. When the second wired, communication section 201 has detected the connection of the device, the second wired communication section 201 notifies the control section 220 of the fact that the device has been connected to the port 202.

Then, the control section 120 of the wireless transmitter 100 determines (step S2) whether or not a transition instruction to the pairing mode has been input from the operation section 121. In the case of a negative determination, the control section 120 does not change the operation mode of the wireless transmitter 100, but keeps (step S11) the wireless transmitter 100 in the normal operation mode. Further, in the case of an affirmative determination, the control section 120 makes the operation mode of the wireless transmitter 100 make the transition to the pairing mode. Further, the control section 120 transmits (step S3) the pairing start request to the projector 200, which has been connected with wire, to make the projector 200 make the transition to the pairing mode. The control section 220 of the projector 200, which has received the pairing start request, makes (step S22) the operation mode of the projector 200 make the transition to the pairing mode,

Then, the control section 120 determines whether or not the projector 200 having been connected with the cable 150 is a device which can wirelessly be connected to the wireless transmitter 100. The control section 120 requests (step S4) the projector 200 for transmission of the determination information. The control section 220 of the projector 200 having received the transmission request of the determination information transmits (step S23) the determination information to the wireless transmitter 100.

When the control section 120 obtains the determination information from the projector 200, the control section 120 determines (step S5) whether or not the wireless connection to the projector 200 is achievable based on the determination information thus obtained.

For example, the control section 120 obtains the information of the supported resolution from the determination information to determine whether or not the projector 200 is capable of display the video data with the resolution as supplied from the video source device 10. Further, the control section 120 obtains the information regarding the number of the wireless channels of the projector 200 from the pairing information. The control section 120 determines whether or not the number of the wireless channels provided to the projector 200 is smaller than the number of the wireless channels (i.e., the number of the wireless transmission sections) provided to the wireless transmitter 100. If the number of the wireless channels provided to the projector 200 is smaller than the number of the wireless channels provided to the wireless transmitter 100, the control section 120 determines that the wireless connection is achievable. Further, in the case in which the video data supplied from the video source device 10 is the content requiring a content protection, the control section 120 determines whether or not the projector 200 is a device supporting the content protection standard.

In the case in which the determination condition described above is not fulfilled, the control section 120 determines (NO in the step S3) that the wireless connection to the projector 200 is not achievable. On this occasion, the control section 120 makes (step S11) the operation mode of the wireless transmitter 100 make the transition from the pairing mode to the normal operation mode. Further, the control section 120 transmits the transition request to the normal operation mode to the projector 200, and then terminates the processing flow.

Further, if the control section 120 has determined that the determination condition described above has been fulfilled, the control section 120 determines (YES in the step S5) that the wireless connection to the projector 200 is achievable. On this occasion, the control section 120 determines the wireless transmission sections (103, 105) to be paired with the wireless reception sections (203, 205) provided to the projector 200 based on the correspondence information included in the determination information. The pairing is performed so that the correspondence between the part of the video data to be transmitted by each of the wireless transmission sections (103, 105) and the whole of the video data coincides with the correspondence between the part of the video data to be received by each of the wireless reception sections (203, 205) and the whole of the video data. The part of the video data (the partial video data) corresponds to the part of the video data divided, by the video dividing section 115.

The control section 120 first determines the division method of the video data and the number of the parts the video data is divided into with reference to the correspondence information. For example, in the case in which the resolution of the video data is 4 k, and the correspondence information thus referred to is set so that the image of one frame represented by the video data is horizontally divided into two parts, the control, section 120 instructs the video dividing section 115 to horizontally divide the video data into two parts.

Further, the control section 120 determines (step S6) the correspondence regarding which one of the parts of the video data thus divided is transmitted under the charge of the wireless transmission section provided to the wireless transmitter 100. For example, in the case in which the correspondence information thus referred to is set so that the first wireless reception section 203 is assigned to the reception of the left one of the two parts into which the video data has been divided (hereinafter referred to as left side video data), the control section 120 first selects the wireless transmission section to foe paired with the first wireless reception section 203. For example, the control section 120 selects the first wireless transmission section 103 as the wireless transmission section to be paired with the first wireless reception section 203. The control section 120 instructs the video dividing section 115 to transmit the left side video data to the first wireless transmission section 103 thus selected.

Further, for example, in the case in which the correspondence information thus referred to is set so that the second wireless reception section 205 is assigned to the reception of the right one of the two parts into which the video data, has been divided (hereinafter referred to as right side video data), the control section 120 selects the wireless transmission section to be paired with the second wireless reception section 205. For example, the control section 120 selects the second wireless transmission section 105 as the wireless transmission section, to be paired with the second wireless reception section 205. The control section 120 instructs the video dividing section 115 to transmit the right side video data to the second wireless transmission section 105 thus selected.

Further, the control section 120 transmits the second identification information of the first wireless reception section 203 assigned to the reception of the left side video data to the first wireless connection control section 104. The first wireless connection control section 104 stores the second identification information transmitted from the control section. 120. Further, the control section 120 transmits the fourth identification information of the second wireless reception section 205 assigned to the reception of the right side video data to the second wireless connection control, section 106. The second wireless connection control section 106 stores the fourth identification information transmitted from the control section 120.

Further, the control section 120 transmits (step S7) the correspondence information, which includes the first identification information for identifying the first wireless transmission section 103, and the information representing the fact that the first wireless transmission section 103 represented by the first identification information is assigned to the transmission of the left side video data, to the control section 220 of the projector 200. Further, the control section 120 transmits (step S7) the correspondence information, which includes the third identification information for identifying the second wireless transmission section 105, and the fact that the second wireless transmission section 105 represented by the third identification information is assigned to the transmission of the right side video data, to the control section 220 of the projector 200.

When the control section 220 of the projector 200 receives (step S24) the correspondence information from the wireless transmitter 100, the control section 220 outputs the first identification information of the first wireless transmission section 103 to the third wireless connection control section 204 based on the correspondence information thus received. The third wireless connection control section 204 stores the first identification information of the first wireless transmission section 103 input from the control section 220. Further, the control section 220 outputs the third identification information of the second wireless transmission section 105 to the fourth wireless connection control section 206 based on the correspondence information received from the wireless transmitter 100. The fourth wireless connection control section 206 stores the third identification information of the second wireless transmission section 105 input from the control section 220.

Subsequently, the wireless transmitter 100 and the projector 200 perform (steps S3, S25) the wireless connection due to the pairing using the identification information,

The first wireless connection control section 104 of the wireless transmitter 100 controls the first wireless transmission section 103 to perform the wireless connection using the pairing. The first wireless transmission section 103 outputs the radio wave, on which the first identification information of the first wireless transmission section 103 and the second identification information of the first wireless reception section 203 are superimposed, to perform a connection request when searching for the device to which the wireless transmitter 100 is wirelessly connected.

The first wireless reception section 203 of the projector 200 receives the radio wave output by the first-wireless transmission section 103, and then performs output to the third wireless connection control section 204.

The third wireless connection control section 204 retrieves the identification information superimposed on the radio wave input from the first wireless reception section 203, namely the first identification information of the first wireless transmission section 103 and the second identification information of the first wireless reception section 203. The third wireless connection control section 204 determines whether or not the first wireless transmission section 103 and the first wireless reception section 203, on which the connection request has been performed, are connected to each other based on the identification information thus retrieved. The third wireless connection control section 204 permits the wireless connection in the case in which the identification information thus retrieved includes the second identification information of the first wireless reception section 203, and the first identification information of the first wireless transmission section 103, which has been designated by the control section 220 as a communication counterpart. The first wireless reception section 203, to which the wireless connection is granted by the third wireless connection control section 204, responds to the connection request of the first wireless transmission section 103.

The second wireless connection control section 106 of the wireless transmitter 100 controls the second wireless transmission section 105 to perform the wireless connection using the pairing. The second wireless transmission section 105 outputs the radio wave, on which the third identification information of the second wireless transmission section 105 and the fourth identification information of the second wireless reception section 205 are superimposed, to perform a connection request when searching for the device to which the wireless transmitter 100 is wirelessly connected.

The second wireless reception section 205 of the projector 200 receives the radio wave output by the second wireless transmission section 105, and then performs output to the fourth wireless connection control section 206.

The fourth wireless connection control section 206 retrieves the identification information superimposed on the radio wave input from the second wireless reception section 205, namely the third identification information of the second wireless transmission section 105 and the fourth identification information of the second wireless reception section 205. The fourth wireless connection control section 206 determines whether or not the second wireless transmission section 105 and the second wireless reception section 205, on which the connection request has been performed, are connected to each other based on the identification information thus retrieved. The fourth wireless connection control section 206 permits the wireless connection in the case in which the identification information thus retrieved includes the fourth identification information of the second wireless reception section 205, and the third identification information of the second wireless transmission section 105, which has been designated by the control section 220 as a communication counterpart. The second wireless reception section 205, to which the wireless connection is granted by the fourth wireless connection control section 206, responds to the connection request of the second wireless transmission section 105.

When the wireless transmitter 100 and the projector 200 are wirelessly connected to each other, the control section 120 instructs the test video pattern generation section 113 to generate the test video data.

The test video data generated by the test video data generation section 113 is output to the video dividing section 115 via the video switching section 114. The video dividing section 115 divides the test video data into two parts in a horizontal direction in accordance with the setting designated by the control section 120. Farther, the video dividing section 115 outputs the left one of the two parts into which the test video data is divided (hereinafter referred to as left side test data) to the first wireless transmission section 103 in accordance with the setting designated by the control section 120. Further, the video dividing section 115 outputs the right one of the two parts into which the test video data is divided (hereinafter referred to as right side test data) to the second wireless transmission section 105.

The first wireless transmission section 103 transmits (step S9) the left side test data to the first wireless reception section 203 of the projector 200 having wirelessly been connected. When the first wireless reception section 203 has received the left side test data (YES in the step 826), the first wireless reception section 203 outputs the left side test data thus received to the video processing section 211.

Further, the second wireless transmission section 105 transmits (step S9) the right side test data to the second wireless reception section 205 of the projector 200 having wirelessly been connected. When the second wireless reception section 205 has received the right side test data (YES in the step S26), the second wireless reception section 205 outputs the right side test data thus received to the video processing section 211.

The video processing section 211 develops the image based on the left side test data input from the first wireless reception section 203 and the image based on the right side test data received from the second wireless reception section 205 on the frame memory to combine the images into an image corresponding to one frame. The image corresponding to one frame combined by the video processing section 211 is output to the display section 212 as the display signal. The display section 212 projects (step S27) the projection image, which is based on the display signal having been output from the video processing section 211, on the screen.

The user visually observes the test video data projected on the screen to determine whether or not the wireless connection between the wireless transmitter 100 and the projector 200 is successful. In the case in which the wireless connection is successful, the user operates the operation section 121 to input the operation input representing the successful completion of the wireless connection. The control section 120 determines (YES in the step S10) the success in the wireless connection in response to input of a signal corresponding to the successful completion from the operation section 121. When the control section 120 determines that the wireless connection is successful, the control section 120 makes (step S11) the operation mode make the transition from the pairing mode to the normal operation mode. Further, the control section 120 transmits the transition request to the normal operation mode to the projector 200, and then terminates the processing flow. The transition request to the normal operation mode can he transmitted to the projector 200 via the cable 150, or can wirelessly be transmitted by the first wireless transmission section 103 or the second wireless transmission section 105. The control section 220 of the projector 200 makes (step S28) the transition to she normal operation mode in response to the request from the wireless transmitter 100, and then terminates the processing flow.

It should be noted that the wireless transmitter 100 shown in FIG. 1 is provided with the test video pattern generation section 113 for generating the test video data to confirm the wireless connection between the wireless transmitter 100 and the projector 200. However, in the case of performing the confirmation of the wireless connection between the wireless transmitter 100 and the projector 200 based on the video data supplied from the video source device 10, it is also possible to adopt a configuration in which the test video pattern generation section 113 is not provided to the wireless transmitter 100.

According to the present embodiment, the following advantages can be obtained.

In the operation of pairing the wireless transmitter 100 and the projector 200 with each other, in the case in which two or more projectors 200 exist adjacent to each other, there is a possibility that the wireless transmitter 100 is paired with unintended one of the projectors 200.

Therefore, in the present embodiment, the wireless transmitter 100 and the projector 200, which are intended to wirelessly be connected to each other, are connected to each other with the cable 150 in a wired manner to transmit and receive the identification information for identifying the communication counterparts of the wireless connection. Then, the wireless transmission sections (103, 105) of the wireless transmitter 100 and the wireless reception sections (203, 205) of the projector 200 are made to wirelessly be connected to each other based on the identification information having been transmitted and received. Therefore, it is possible to make the wireless transmitter 100 and the projector 200, which are intended to be connected to each other, wirelessly be connected to each other with a simple operation.

Further, the wireless transmitter 100 is provided with a plurality of wireless transmission sections (103, 105), and the projector 200 is provided with a plurality of wireless reception sections (203, 205). Each of the wireless transmission sections (103, 105) provided to the wireless transmitter 100 is associated with either one of the wireless reception sections (203, 205) provided to the projector 200, and performs the wireless transmission. Farther, the wireless transmitter 100 obtains two or more partial video data as parts of the video data, and then transmits the partial video data while assigning any of the partial video data to each of the two or more wireless transmission sections (103, 105). The projector 200 receives the plurality of partial video data transmitted by the respective wireless transmission sections (103, 105) using the plurality of wireless reception sections (203, 205), and then displays the picture based on the plurality of partial video data thus received. Therefore, it is possible to transmit the plurality of partial video data as the parts of the video data thus obtained to the projector 200 while being assigned to the respective wireless transmission sections (103, 105).

Further, in the case of transmitting the high resolution video data such as 4 k video data, it is assumed to connect the wireless transmitter 100 and the projector 200 to each other with a plurality of wireless communication channels for the purpose of ensuring a broad band. Therefore, in the present embodiment, the pairing is performed so that the correspondence between the part of the video data to be transmitted by each of the wireless transmission sections (103, 105) and the whole of the video data coincides with the correspondence between the part of the video data to be received by each of the wireless reception sections (203, 205) and the whole of the video data. In other words, the wireless transmission section (103, 105) and the wireless reception section (203, 205) to be paired with each other are assigned to the transmission and the reception of the same part of the video data thus divided. Thus, it is possible for the projector 200 to combine the parts of the video data received by the respective wireless reception sections (203, 205) with each other to reproduce the video data, which is the original to be divided, and then project the video data on the screen.

Further, the control section 120 of the wireless transmitter 100 determines whether or not the number of the wireless reception sections (203, 205) provided to the projector 200 is smaller than the number of the wireless transmission sections (103, 105) provided to the wireless transmitter 100. Therefore, the number of the partial video data and so on to be transmitted by the wireless transmitter 100 can appropriately be set in accordance with the configuration of the projector 200.

Further, the information to be transmitted and received by the wireless transmitter 100 and the projector 200 includes the information for the wireless transmitter 100 to identify the wireless reception sections (203, 205) of the projector 200. Further, the information to be transmitted and received includes the information for the projector 200 to identify the wireless transmission sections (103, 105) of the wireless transmitter 100. Therefore it is possible to make the wireless transmitter 100 identify the wireless reception sections of the projector 200, and further, it is possible to make the projector 200 identify the wireless transmission sections of the wireless transmitter 100.

Further, in the wireless transmitter 100, the video data for confirming the connection is transmitted from the wireless transmission section (103, 105) to the wireless reception section (203, 205) associated with each other by the pairing. Therefore, due to the function of the wireless transmitter 100, the connection to the projector 200 associated therewith by the pairing can be confirmed.

Further, the wireless transmitter 100 is provided with the operation section 121 for receiving operations, and performs the transmission and the reception of the identification information, and the pairing in accordance with the operation received by the operation section 121. Further, the projector 200 starts the transmission and the reception of the identification information and the pairing based on the control data transmitted from the wireless transmitter 100. Therefore, it is possible to pair the wireless transmitter 100 and the projector 200 with each other using the operation to the operation section 121 provided to the wireless transmitter 100.

Further, the first wired communication section 101 of the wireless transmitter 100 and the second wired communication section 201 of the projector 200 correspond to the interface for transmitting the HD video data with wire. Therefore, the identification information can be transmitted and received using the interface for transmitting the HD video data.

### Second Embodiment

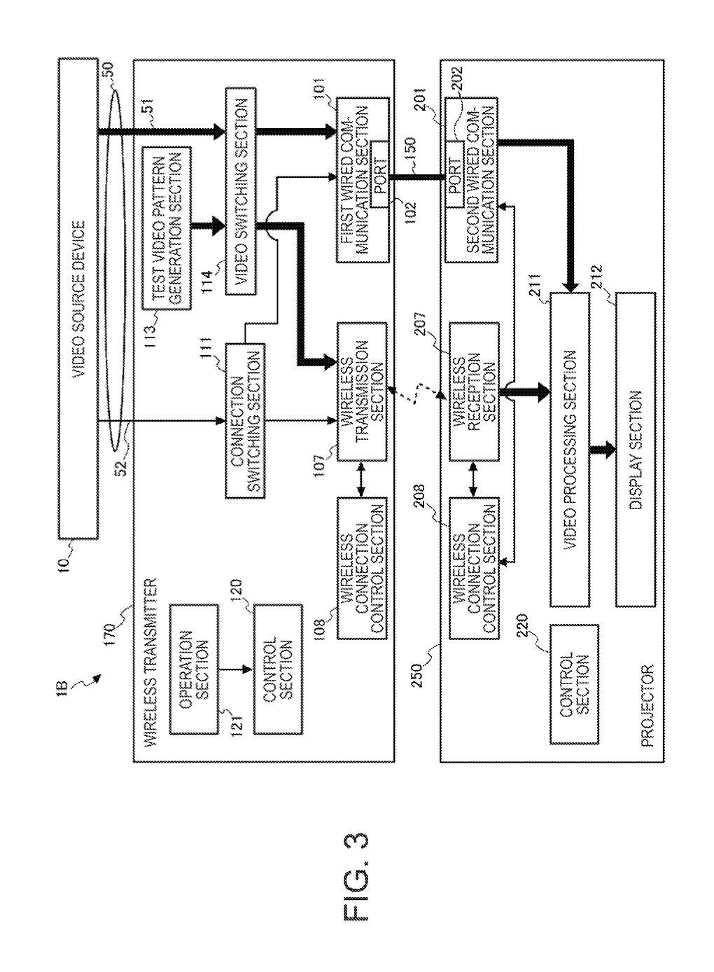

FIG. 3 is a diagram showing a configuration of a display system 1B according to a second embodiment to which the invention is applied. It should be noted that the sections configured similarly to the first embodiment out of the functional sections shown in FIG. 3 will be denoted with the same reference symbols, and the explanation thereof will be omitted.

The display system 1B is provided with a wireless transmitter 170 and a projector 250.

Similarly to the wireless transmitter 100 of the first embodiment, the wireless transmitter 170 is provided with the first wired communication section 101, the connection switching section 111, the test video pattern generation section 113, the video switching section 114, the control section 120, and the operation section 121. Further, the wireless transmitter 170 is different from the wireless transmitter 100 in the point that one wireless transmission section 107 and one wireless connection control section 108 are provided.

Further, similarly to the projector 200 explained in the description of the first embodiment, the projector 250 is provided with the second wired communication section 201, the video processing section 211, the display section 212, and the control section 220. Further, the projector 250 is different from the projector 200 in the point that one wireless reception section 207 and one wireless connection control section 200 are provided.

The display system 1A shown in FIG. 1 has the configuration in which the wireless transmitter 100 is provided with a plurality of wireless transmission sections (103, 105), and is wirelessly connected to the plurality of wireless reception sections (203, 205) provided to the projector 200. Hers, the number of the wireless transmission sections provided to the wireless transmitter 100 and the number of the wireless reception sections provided to the projector 200 are not particularly limited, but can also be one or no smaller than three. Therefore, the configuration of using one wireless transmission section and one wireless reception section will be explained as the second embodiment.

The display system 1B wirelessly transmits the video data from the wireless transmitter 170 provided with one wireless transmission section 107 to the projector 250 provided with one wireless reception section. Further, the first wired communication section 101 of the wireless transmitter 170 and the second wired, communication section 201 of the projector 250 can wirelessly connected to each other with the cable 150.

Similarly to the display system 1A according to the first embodiment, the display system 1B can perform the operation shown in FIG. 2. In the second embodiment, the pairing information can include the information regarding the number (one, in this case) of wireless channels in which the projector 200 can perform the communication, or can also be omitted. The wireless transmitter 170 eliminates the process of the step S6 shown in FIG. 2. Besides this process, the wireless transmitter 170 and the projector 250 perform the operation shown in FIG. 2, and thus the pairing can be achieved. Further, when the pairing has been, performed and the wireless transmission section 107 and the wireless reception section 207 of the display system 1B have wirelessly been connected to each other, the video switching section 114 outputs the test video data generated by the test video pattern generation section 113 to the wireless transmission section 107. The wireless transmission section 107 transmits the video data thus input to the wireless reception section 207 of the projector 250 using the wireless communication.

The projector 250 performs the video processing on the video data, which has been received by the wireless reception section 207, using the video processing section 211, and then develops the video data on the frame memory provided to the video processing section 211. The image of each frame developed on the frame memory is output from the video processing section 211 to the display section 212 as the display signal, and is then projected, on the screen. The user visually observes the test video data projected on the screen to determine whether or not the wireless connection between the wireless transmitter 100 and the projector 200 is successful. In the case in which the wireless connection is successful, the user operates the operation section 121 to input the operation input representing the successful completion of the wireless connection.

In the second embodiment, in the configuration of transmitting the video data from the wireless transmitter 170 to the projector 250 via one wireless communication channel, substantially the same advantage as in the first embodiment described above can be obtained. Since the display system 1B is provided with one wireless transmission section 107 and one wireless reception section 207, the process of making the assignment of the partial video data to the plurality of wireless transmission sections and the assignment of the partial video data to the plurality of wireless reception sections coincide with each other is unnecessary. However, in the case in which another device performing the wireless communication exists within a range in which the wireless transmission section 107 and the wireless reception section 207 can wirelessly communicate with each other when performing the pairing, there is a possibility that the another device responds during the pairing. In the second embodiment, by transmitting and receiving the pairing information via the cable 150, the wireless transmitter 170 and the projector 250 can be associated with each other using the pairing without passing through the procedure in which another device responds.

The wireless transmitters 100, 170 and the projectors 200, 2110 of the first and second embodiments operate with a standardised wireless communication protocol such as WirelessHD as an example. Since there are a lot of devices compatible with this kind of wireless communication protocol, in the case of performing the pairing with respect to the wireless transmitters 100, 170 and the projectors 200, 250, there is a possibility that the device operating with the similar wireless communication protocol exists in the periphery. Further, before shipment of the product or in an outlet store, it is possible to perform the pairing under the circumstances in which a plurality of wireless transmitters 100, 170 or a plurality of projectors 200, 250 exists. Even under such circumstances, according to the display systems 1A, 1B explained in the description of the first and second embodiments, the wireless transmitter 100, 170 and the projector 200, 250, which are intended to be associated with each other, can be associated with- each other by pairing using the cable 150.

Further, the operation explained in the description of the first and second, embodiments does not require a change in the standardized wireless communication protocol. Therefore, the operation can be realized without being subject to the restriction of the wireless communication protocol standard.

It should be noted that each of the embodiments described above is a preferred embodiment of the invention. It should be noted that the invention is not limited to the embodiments, but can be implemented with a variety of modifications within the scope or the spirit of the invention.

For example, in the first embodiment, the first identification information of the first, wireless transmission section 103 and the second identification information of the first wireless reception section 203 are exchanged between the wireless transmitter 100 and the projector 200. Further, when performing the pairing, the first wireless transmission section 103 performs the connection request on the first-wireless reception section 203 by transmitting the radio wave on which the first identification information of the first wireless transmission section 103 and the second identification information of the first wireless reception section 203 are superimposed.

However, if at least the second identification information of the first wireless reception section 203 is superimposed on the radio wave output fey the first wireless transmission section 103, it is possible for the third wireless connection section 204 to identify the first wireless transmission section 103 of the wireless transmitter 100. Therefore, when exchanging the identification information, if the wireless transmitter 100 obtains the second identification information of the first wireless reception section 203, and then makes the first wireless connection control section 104 store the second identification information, the pairing between the first wireless transmission section 103 and the first wireless reception section 203 can be realized. Similarly, when exchanging the identification information, if the wireless transmitter 100 obtains the fourth identification information of the second wireless reception section 205, and then makes the second wireless connection control section 106 store the fourth identification information, the pairing between the second wireless transmission section 105 and the second wireless reception section 205 can be realized.

Further, each of the embodiments described above corresponds to an example of wirelessly connecting the wireless transmitter 100, 170 and the projector 200, 250 to each other under the control by the control section 120. As a different configuration from the embodiments, it is also possible to make the wireless transmitter 100, 170 operate under the control of the control section 220 to wirelessly connect the wireless transmitter 100, 170 and the projector 200, 250 to each other. In more detail, if the first-identification information of the first wireless transmission section 103 is transmitted from the wireless transmitter 100 to the projector 200, and the third wireless connection control section 204 stores the first identification information, the first wireless transmission section 103 and the first wireless reception section 203 are paired with each other. Similarly, if the third identification information of the second wireless transmission section 105 is transmitted from the wireless transmitter 100 to the projector 200, and the fourth wireless connection control section 206 stores the third identification information, the second wireless transmission section 105 and the second wireless reception section 205 are paired with each other. The same applies to the case of pairing the wireless transmitter 170 and the projector 250 of the second embodiment with each other.

Further, in the first embodiment, an example of dividing the image corresponding to one frame of the video data into two parts in a horizontal direction is explained as an example of dividing the video data. The division method of the video data is not limited to the method, described above, but the video data can be divided in a variety of configurations. For example, it is also possible to adopt a configuration of dividing the image corresponding to one frame of the video data into two parts in a vertical direction. Further, the number of the parts into which the image is divided is not limited to two, but can also be three or four. Further, it is also possible to adopt a configuration of dividing the video data into an even field and an odd field.

Further, in the first embodiment, there is shown an example of the configuration in which the high resolution video data is transmitted and received after dividing the video data into a plurality of low resolution video data to thereby suppress the band per channel, namely the amount of data transmitted and received per unit time by one wireless transmission section and one wireless reception section. According to this configuration, there is an advantage that the video data with the data amount exceeding the limit of the band per channel can be transmitted and received. However, the application target of the invention is not limited to this example. For example, the invention can also be applied in the case of transmitting the 3D (stereoscopic) video data from the wireless transmitter 100 to the projector 200. The video data of the left-eye frame and the video data of the right-eye frame are respectively transmitted by the first wireless transmission section 103 and the second wireless transmission section 105. On this occasion, the projector 200 receives the video data of the left-eye frame and the video data of the right-eye frame with the first wireless reception section 203 and the second wireless reception section 205, respectively. On this occasion, the video dividing section 115 respectively generates the video data constituted by the left-eye frames and the video data constituted by the right-eye frames from the 3D video data input from the video source device 10. The 3D video data input from the video source device 10 includes the left-eye frames and the right-eye frames using, for example, a side-by-side method, a frame-sequential method, a line-by-line method, or a top-and-bottom method. The video dividing section 115 divides the frames of the video data in accordance with these methods to generate the video data of the left-eye frame and the video data of the right-eye frame. Here, the video dividing section 115 can also perform a resolution conversion process if necessary. Further, the video processing section 211 the projector 200 can display the video data of the left-eye frame and the video data of the right-eye frame respectively received by the first wireless reception section 203 and the second wireless reception section 205 on the display section 212 without combining the video data of the left-eye frame and the video data of the right-eye frame with each other. For example, in the case in which the projector 200 displays the 3D picture based on the 3D video data using an active shutter system, the display section 212 alternately displays the left-eye frame and the right-eye frame in sync with the operation timing of an eyeglass-type display using the active shutter system. On this occasion, the high-resolution 3D video data can be transmitted to the projector at a transfer rate exceeding the limit of the band per channel in the display system 1A. Further, in the projector 200, a process of combining the video data once divided is unnecessary. Further, it becomes unnecessary for the projector 200 to perform the process of, for example, clipping the left-eye frame and the right-eye frame from the 3D video data, and adjusting the aspect ratio using the resolution conversion. Therefore, there is an advantage that, for example, it is possible to reduce the load of the process of the projector 200 to reduce the processing delay.

Further, in each of the embodiments described above, the explanation is presented citing the configuration, in which the wireless transmitter 100, 170 generates the test video data using the test video pattern generation section 113 to output the test video data to the video switching section 114, as an example. The invention is not limited to this example, bat it is also possible to adopt a configuration in which the wireless transmitter 100, 170 is not provided with the test video pattern generation section 113. In this case, by inputting the test video data to the wireless transmitter 100, 170 after the display system 1A, 1B performs the pairing, and then transmitting the test video data to the projector 200, 250, the connection confirmation can be performed.

Further, the display device according to the invention is not limited to the projector 200, 250 for projecting an image on the screen. For example, the display device can also be a liquid crystal monitor or a liquid crystal television for displaying an image or a picture on a liquid crystal display panel, or a monitor device or a television set for displaying an image or a picture on a plasma display panel (PDP). Further, the display device can also be a light emitting display device such as a monitor device or a television set for displaying an image or a picture on an organic EL display panel called an organic light-emitting diode (OLED), an organic electro-luminescence (OEL), and so on. In this case, the liquid crystal display panel, the plasma display panel, and the organic EL display panel correspond to the display section.

Further, each of the functional sections of the display system 1A, 1B shown in FIGS. 1 and 3 is for showing the functional configuration realized by the cooperation of hardware and software, and the specific mounting configurations are not particularly limited. Therefore, it is not necessarily required to install the hardware corresponding individually to each of the functional sections, but it is obviously possible to adopt a configuration of realizing the functions of the plurality of functional sections by one processor executing a program. Further, a part of the function realized by the software in the embodiment described above can also be realized by the hardware, or a part of the function realized by the hardware can also be realized by the software. Besides the above, the specific detailed configuration of each of the sections of the display system 1A, 1B can arbitrarily be modified within the scope or the spirit of the invention.

What is claimed is:

2. The display system according to claim 1, wherein
the transmitting device is provided with a plurality of the wireless transmission sections,
the display device is provided with a plurality of the wireless reception sections,
each of the wireless transmission sections provided to the transmitting device is associated with either one of the wireless reception sections provided to the display device to perform wireless transmission,
the transmitting device obtains a plurality of partial video data as parts of the video data, and then transmits the partial video data while assigning any of the partial video data to each of the wireless transmission sections, and
the display device receives the plurality of partial video data transmitted by the respective wireless transmission sections using the plurality of wireless reception sections, and then displays the picture based on the plurality of partial video data received.

3. The display system according to claim 2, wherein
the display device displays a picture based on the plurality of the partial video data received by the plurality of the wireless reception sections in accordance with a correspondence relationship between the partial video data received by each of the wireless reception sections and a whole of the video data, and
the transmitting device and the display device performs the pairing by associating the wireless transmission section and the wireless reception section with each other so that correspondence between the partial video data transmitted by the wireless transmission section and the whole of the video data and correspondence between the partial video data received by the wireless reception section and the whole of the video data are coincide with each other.

4. The display system according to claim 2, wherein
the transmitting device has a determination section adapted to determine whether or not a number of the wireless reception sections provided to the display device is smaller than a number of the wireless transmission sections provided to the transmitting device.

5. The display system according to claim 1, wherein
the transmitting device and the display device transmit and receive the identification information including at least either one of information used by the transmitting device for identifying the wireless reception section of the display device, and information used by the display device for identifying the wireless transmission section of the transmitting device.

6. The display system according to claim 1, wherein
the transmitting device transmits video data for connection confirmation to the display device associated by the pairing.

7. The display system according to claim 1, wherein
the transmitting device has an operation section adapted to receive an operation, and performs the transmission and the reception of the identification information, and the pairing in accordance with the operation received by the operation section, and
the display device starts the transmission and the reception of the identification information and the pairing based on control data transmitted from the transmitting device.

8. The display system according to claim 1, wherein
the wired connection section of the transmitting device and the wired connection section of the display device are compatible with an interface adapted to transmit HD video data with wire.

9. A transmitting device comprising:
a wired connection section to be connected to an external device with wire; and
a wireless communication section adapted to perform wireless communication with the external device,
wherein in a case in which the wired connection section is connected to the external device with wire, identification information used to identify the -external device is obtained from the external device using the wireless communication section, and
pairing adapted to associate the wireless communication section with the external device is performed based on the identification information obtained from the external device, and the video data is transmitted from the wireless communication section to the external device associated with each other using the pairing.

10. A method of controlling a display system comprising:
providing a transmitting device adapted to transmit video data, and a display device adapted to receive the video data to display a picture based on the video data to the display system;
transmitting and receiving identification information, which is used in a case in which the transmitting device and the display device perform wireless communication, via a wired transmission channel connecting the transmitting device and the display device to each other;
performing pairing adapted to associate the transmitting device and the display device performing wireless communication with each other based on the identification information; and
transmitting the video data from the transmitting device to the display device, which are associated with each other using the pairing, with wireless communication.
